(19) United States
(12) Patent Application Publication
(10) Pub. No.: US 2011/0229304 A1
(43) Pub. Date: Sep. 22, 2011

(54) Vertical axis wind turbine system

(76) Inventor: Shu Fang, Plainsboro, NJ (US)

(21) Appl. No.: 12/661,489

(22) Filed: Mar. 18, 2010

(51) Int. Cl. F03D 3/02; F03D 3/04

(52) U.S. Cl. 415/60

(57) ABSTRACT

A wind turbine system utilizes three vertical shaft rotor units, each rotor unit consisting of three blades. The rotor units are synchronized such that the blades of each unit are maintained at twenty degree intervals, so as to capture head on wind at maximum efficiency. The front rotor unit comprises baffles which appropriately redirect airflow to the rotor units. A stabilizing fin is provided to ensure that the wind turbine system is always headed into the prevailing wind. The system achieves near one hundred percent efficient use of ongoing ambient wind.

### FIELD OF THE INVENTION

The present invention relates to a wind turbine system rotatable about a plurality of vertical axes, and having a configuration specifically designed to greatly increase the efficiency of wind energy utilization without unreasonably adding to the process or to the cost of manufacture.

### BACKGROUND OF THE INVENTION

Wind generated turbines of various designs and configurations, including those which employ vertical axes, are well known. Yet a significant disadvantage of these wind turbines is that their blades, which are designed to accept the ongoing wind, are configured such that the full force of the wind cannot at all times act on the blades themselves. For instance, wind turbine blades are situated such that as their respective shafts rotate, a subsequent blade in the direction of the rotation blocks its predecessor as it moves into position to catch ongoing wind. Blades which are not positioned to receive ongoing wind can actually be a detriment to providing wind power to operate the turbine. In fact, it has been estimated that in excess of eighty percent of the energy of wind or moving air which engages and acts upon blades used in wind turbines is lost as a result of these conditions and the deflection and the slippage of air from the tips and/or trailing edges of the blades. The deflection or change of direction of moving air also wastefully reduces much of the energy carried by the wind. When redirected air slips from or leaves the blades, significant energy is lost. As a result, most wind powered turbines are inefficient and oft times ineffective.

Much of the cause of the loss of wind energy is occasioned by the fact that there is little or no control of the blades of wind turbines in relation to each other. The blades of wind turbines are generally designed to rotate freely and as fast as the wind moves them, in the direction the wind is blowing. Current wind turbines have no coordination between rotating blades nor is any effort made to configure blades to operate at maximum efficiency, that is to capture and turn into energy as much of the wind as possible.

### SUMMARY OF THE INVENTION

It is thus the object of the present invention to provide a wind turbine system which overcomes the limitations and disadvantages of prior wind turbine devices.

It is the object of the present invention to provide a wind turbine which utilizes a plurality of rotor units to efficiently and effectively capture wind flow and use this flow at near one hundred percent efficiency.

These and other objectives are accomplished by the present invention, a wind turbine system which utilizes three vertical shaft rotor units, each rotor unit consisting of three blades. The rotor units are synchronized such that the blades of each unit are maintained at twenty degree intervals, so as to capture head on wind at maximum efficiency. The front rotor unit comprises baffles which appropriately redirect airflow to the rotor units. A stabilizing fin is provided to ensure that the wind turbine system is always headed into the prevailing wind. The system achieves near one hundred percent efficient use of ongoing ambient wind.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective view of the wind turbine system in accordance with the present invention.

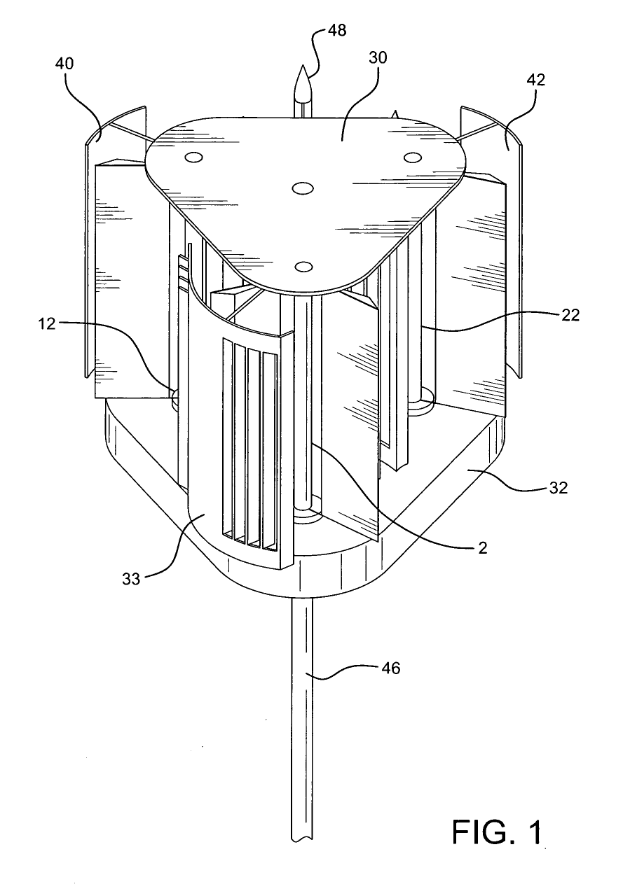

FIG. 2 is a perspective view of the wind turbine system in accordance with the present invention with its top bracket plate removed.

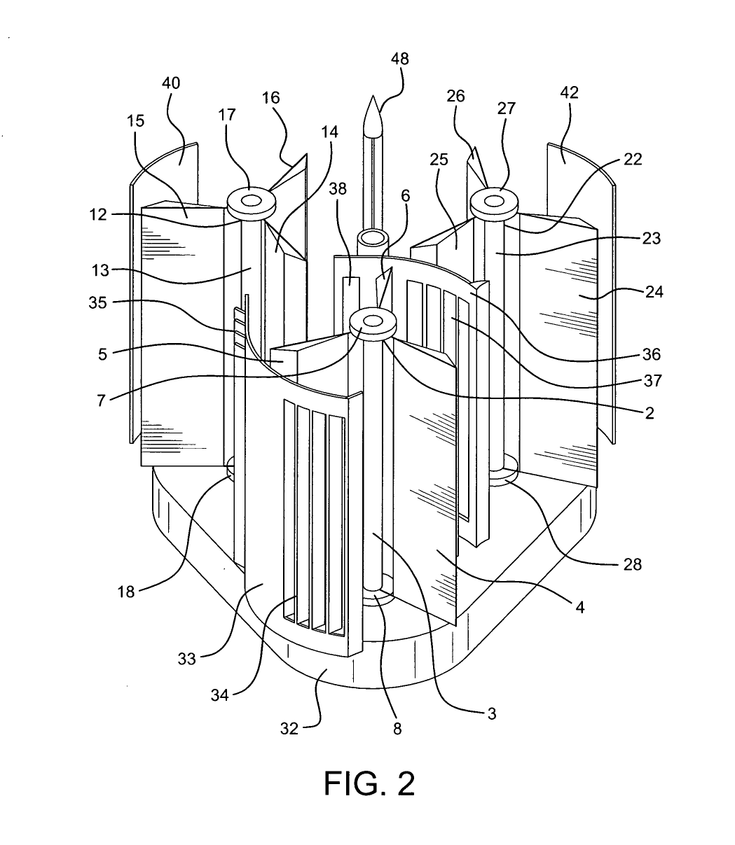

FIG. 3 is an elevation view of the wind turbine system in accordance with the present invention.

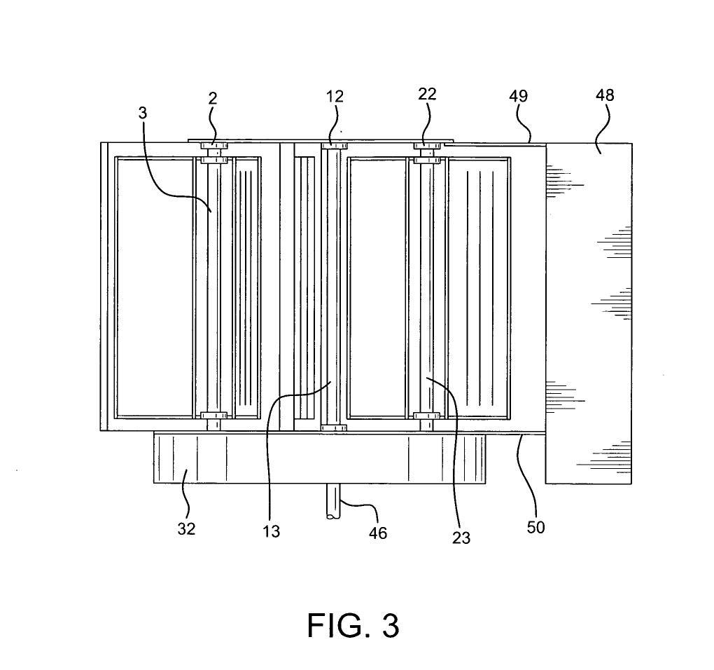

FIG. 4 is a top view of the internal components of the control housing of the present invention.

FIG. 5 is a schematic top view showing airflow in the wind turbine system in accordance with the present invention.

FIG. 6 is a schematic showing calculation of airflow/blade efficiency.

### DETAILED DESCRIPTION OF THE INVENTION

The wind turbine system of the present invention comprises three rotor units: forward rotor unit 2, left rear rotor unit 12 and, right rear rotor unit 22. Rotor unit 2 comprises vertical rotor unit shaft 3. Three blades 4, 5, and 6, spaced 120° apart, extend from collar bearings 7 and 8 around shaft 3. In like fashion, rotor unit 12 comprises vertical rotor shaft 13. Three blades 14, 15, and 16, spaced 120° apart, extend from collar bearings 17 and 18 around shaft 13. Rotor unit 22 comprises vertical rotor shaft 23. Three blades 24, 25, and 26, spaced 120° apart, extend from collar bearings 27 and 28 around shaft 23.

Rotor units 2, 12, and 22 are vertically mounted by means of their respective shafts 3, 13, and 23, between top bracket plate 30 and control housing 32. The rotor units are mounted in triangular configuration between the top bracket and the control housing.

Curved baffle plate 33, having two sets of vertically oriented slots 34 and 35 extend from shaft 3 of rotor unit 2, substantially at the front of wind turbine system 1. Curved baffle plate 36, having two sets of vertically oriented slots 37 and 38, extend from shaft 3, substantially at the rear of the wind turbine system. Airflow deflectors 40 and 42 extend from shafts 13 and 23 respectively of rotor units 12 and 22. The airflow deflectors are also curved, and are solid, having continuous, uninterrupted surfaces, free from slots or other openings.

Vertical pole 46, located equidistant between shafts 3, 13, and 23, extends through control housing 32 and top bracket 30. In this manner, wind turbine system 1 is mounted atop pole 46. Fin stabilizer 48 rotatably extends from pole 46, via control arms 49 and 50.

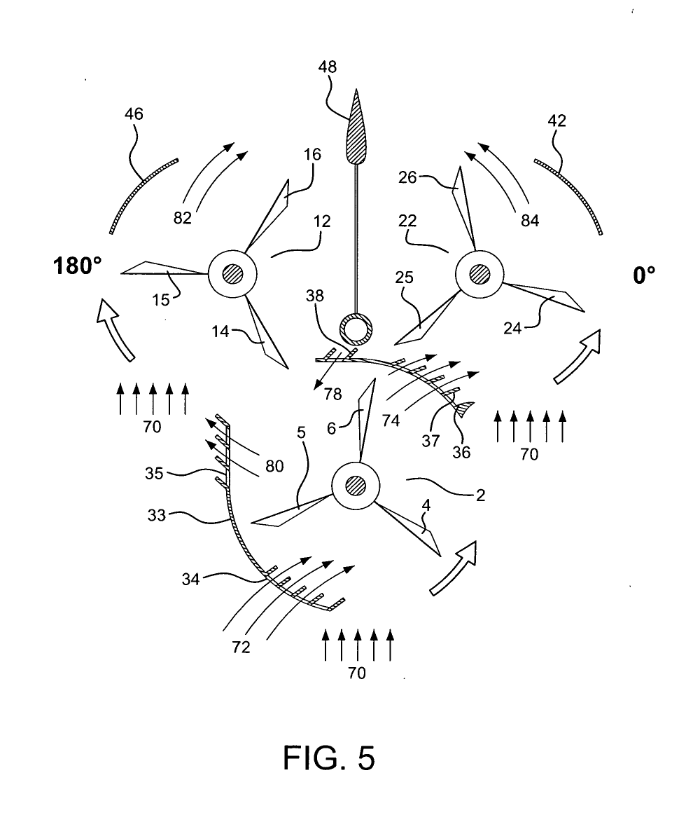

The three rotor units 2, 12, and 22 are synchronized such that their respective, corresponding blades are always 20° apart. That is (with specific reference to FIG. 5 which depicts 0° at the right side of the rotor units and 180° at the left side of the rotor units), the blades of rotor unit 2 are always 20° forward of the blades of rotor unit 12, e.g. blade 5 at 200°; blade 15 at 180°; blade 4 at 320°; blade 14 at 300°; blade 6 at 80°; blade 16 at 60°. In like manner the blades of rotor unit 2 are always 20° behind the blades of rotor unit 22, e.g. blade 5 at 200°; blade 25 at 220°; blade 4 at 320°; blade 24 at 340°; blade 6 at 80°; blade 26 at 100°.

The following chart lists the angular orientation of each blade of rotor units 2, 12, and 22, as they rotate 360°, beginning with position 1, the position in which the blades in FIG. 5 are configured:

| | LEFT REAR | | | FORWARD | | | RIGHT REAR | | |
|---|---|---|---|---|---|---|---|---|---|
| | ROTOR UNIT (12) | | | ROTOR UNIT (2) | | | ROTOR UNIT (22) | | |
| Posi- | Blade | Blade | Blade | Blade | Blade | Blade | Blade | Blade | Blade |
| tion | (15) | (14) | (16) | (5) | (4) | (6) | (25) | (24) | (26) |
| 1 | 180 | 300 | 60 | 200 | 320 | 80 | 220 | 340 | 100 |
| 2 | 170 | 290 | 50 | 210 | 330 | 90 | 230 | 350 | 110 |
| 3 | 160 | 280 | 40 | 220 | 340 | 100 | 240 | 0 | 120 |
| 4 | 150 | 270 | 30 | 230 | 350 | 110 | 250 | 10 | 130 |
| 5 | 140 | 260 | 20 | 240 | 0 | 120 | 260 | 20 | 140 |
| 6 | 130 | 250 | 10 | 250 | 10 | 130 | 270 | 30 | 150 |
| 7 | 120 | 240 | 0 | 260 | 20 | 140 | 280 | 40 | 160 |
| 8 | 110 | 230 | 350 | 270 | 30 | 150 | 290 | 50 | 170 |
| 9 | 100 | 220 | 340 | 280 | 40 | 160 | 300 | 60 | 180 |
| 10 | 90 | 210 | 330 | 290 | 50 | 170 | 310 | 70 | 190 |
| 11 | 80 | 200 | 320 | 300 | 60 | 180 | 320 | 80 | 200 |
| 12 | 70 | 190 | 310 | 310 | 70 | 190 | 330 | 90 | 210 |
| 13 | 60 | 180 | 300 | 320 | 80 | 200 | 340 | 100 | 220 |
| 14 | 50 | 170 | 290 | 330 | 90 | 210 | 350 | 110 | 230 |
| 15 | 40 | 160 | 280 | 340 | 100 | 220 | 0 | 120 | 240 |
| 16 | 30 | 150 | 270 | 350 | 110 | 230 | 10 | 130 | 250 |
| 17 | 20 | 140 | 260 | 0 | 120 | 240 | 20 | 140 | 260 |
| 18 | 10 | 130 | 250 | 10 | 130 | 250 | 30 | 150 | 270 |
| 19 | 0 | 120 | 240 | 20 | 140 | 260 | 40 | 160 | 280 |
| 20 | 350 | 110 | 230 | 30 | 150 | 270 | 50 | 170 | 290 |
| 21 | 340 | 100 | 220 | 40 | 160 | 280 | 60 | 180 | 300 |
| 22 | 330 | 90 | 210 | 50 | 170 | 290 | 70 | 190 | 310 |
| 23 | 320 | 80 | 200 | 60 | 180 | 300 | 80 | 200 | 320 |
| 24 | 310 | 70 | 190 | 70 | 190 | 310 | 90 | 210 | 330 |
| 25 | 300 | 60 | 180 | 80 | 200 | 320 | 100 | 220 | 340 |
| 26 | 290 | 50 | 170 | 90 | 210 | 330 | 110 | 230 | 350 |
| 27 | 280 | 40 | 160 | 100 | 220 | 340 | 120 | 240 | 0 |
| 28 | 270 | 30 | 150 | 110 | 230 | 350 | 130 | 250 | 10 |
| 29 | 260 | 20 | 140 | 120 | 240 | 0 | 140 | 260 | 20 |
| 30 | 250 | 10 | 130 | 130 | 250 | 10 | 150 | 270 | 30 |
| 31 | 240 | 0 | 120 | 140 | 260 | 20 | 160 | 280 | 40 |
| 32 | 230 | 350 | 110 | 150 | 270 | 30 | 170 | 290 | 50 |
| 33 | 220 | 340 | 100 | 160 | 280 | 40 | 180 | 300 | 60 |
| 34 | 210 | 330 | 90 | 170 | 290 | 50 | 190 | 310 | 70 |
| 35 | 200 | 320 | 80 | 180 | 300 | 60 | 200 | 320 | 80 |
| 36 | 190 | 310 | 70 | 190 | 310 | 70 | 210 | 330 | 90 |
| 1 | 180 | 300 | 60 | 200 | 320 | 80 | 220 | 340 | 100 |

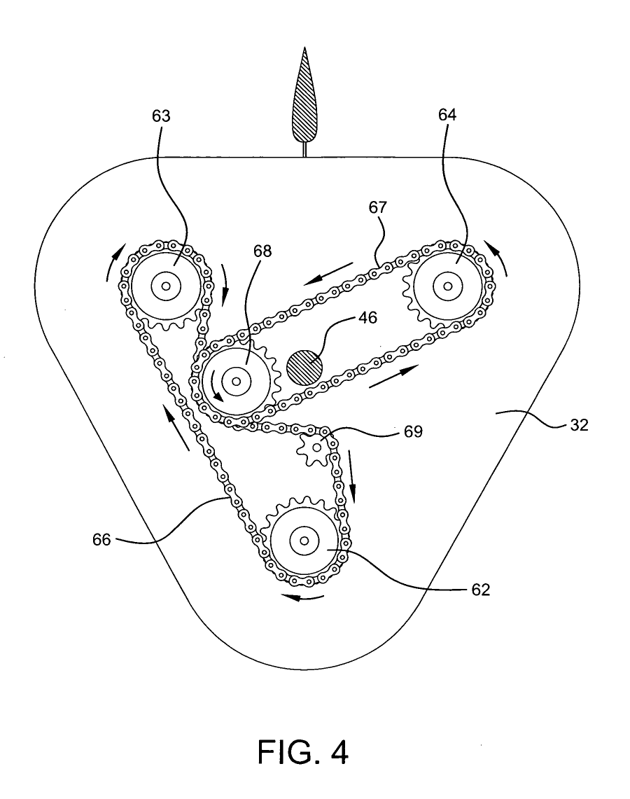

The blades in rotor units 2, 12 and 22 are synchronized at the above described 20° separation by means of the synchronize gear/chain system depicted in FIG. 4, showing the internals of control housing 32. The lower end of shaft 3 of rotor unit 2 is keyed to pinion gear 62. The lower end of shaft 13 of rotor unit 12 is keyed to pinion gear 63. The lower end of shaft 23 of rotor unit 22 is keyed to pinion gear 64. Each shaft is thus secured to their respective pinion gear such that the 20° angle difference between the blades extending from the upper ends of the shafts is, at all times, maintained.

As the blades of rotor units 2, 12, and 22 rotate, shafts 3, 13, and 23 are rotated, and so too are pinion gears 62, 63, and 64. This rotative action serves to rapidly rotate power output pinion gear 68, via gear chains 66 and 67, the drive pinion gear 69 which leads to an alternator or similar power generating device.

Wind generated airflow is utilized with almost 100% efficiency by wind turbine system 1. With specific reference to FIG. 5, fin stabilizer 48 serves to maintain the wind turbine system oriented so that forward rotor unit 2 is the forwardmost rotor unit which, at all times, faces head-on prevailing ambient wind or airflow 70. In the configuration shown in FIG. 5, blade 15 of rotor unit 12 is at 180°. Therefore, it receives direct and full head-on airflow 70, which results in blade 15, in this position, utilizing airflow and rotating with 100% efficiency.

Again with reference to FIG. 5, blade 4 of rotor unit 2, shown as being at an angle of 320°, is also impacted by head-on airflow 70. However, since blade 4 is at an angle to horizontal, airflow is not being utilized at 100% efficiency. Nonetheless, blade 4 also receives secondary airflow 72, which is the airflow directed from baffle plate 33 through slots 34. This results in blade 4 utilizing the airflow provided by the wind at approximately 77% efficiency.

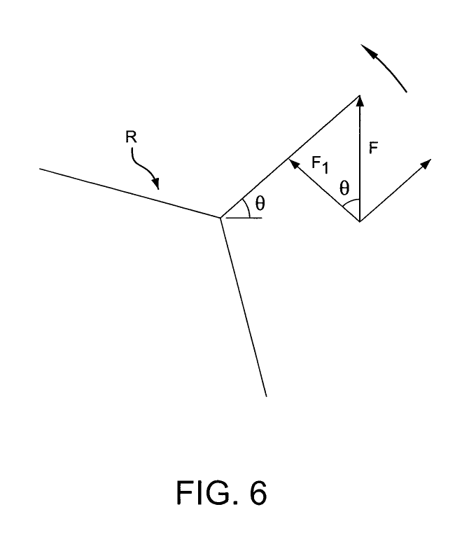

FIG. 6 schematically shows the calculation of airflow efficiency against effected blades of a rotor R. F represents the direct force of the wind (100% efficiency on a horizontal blade), F1 the percentage efficiency based on the angular position of the blades, i.e. the actual force derived from the wind impacting the blade at this angle, and Ø the angle between the blade and the horizontal. Here, F1=F×cos Ø.

Expanding this analysis to the other blades, it can be seen that blade 6 of rotor unit 2 will only be impacted minimally by the residual airflow 74 which is directed out of rotor unit 2 through slots 37 in baffle plate 36. Discharged residual airflow 78 from rotor unit 22 is expelled through slot 38 of baffle plate 36 and does not effect blade 6. The wind utilization efficiency of blade 6 is 17%. Blade 5 of rotor unit 2 experiences virtually no benefit from any wind generated airflow, so its efficiency in this position is 0%. Discharged residual airflow 80 is expelled from rotor unit 2 through slots 35 of baffle plate 33.

Deflector 40 of rotor unit 12 effectively expels discharged residual airflow 82 from blade 15 out of the rotor unit. Blades 14 and 16 are substantially unaffected by wind airflow and so their efficiencies are each 0%, when in the position depicted in FIG. 5.

Blade 24 of rotor unit 22 is at an angle of 340°, almost, but not quite, at the horizontal 0° angle, which represents 100% efficiency. Blade 24 receives head on airflow 70 as well as secondary airflow 74 directed from rotor unit 2 through slots 37 of baffle plate 36. It thus operates at 94% efficiency in this position. Like deflector 40, discussed alone, deflector 42 expels discharged residual airflow 84 from blade 24 out of rotor unit 22. Blades 25 and 26 are substantially unaffected by wind airflow and so their efficiencies are each 0%, when in the position depicted in FIG. 5.

The sum of the wind use efficiencies of the three rotor units 2, 12, and 22 is 288% (blade 4—77%; blade 6—17%; blade 15—100%; blade 24—94%). Since the maximum cumulative wind use efficiency can only be 300% (100% for each of the three rotor units), the current invention provides a system which has an overall efficiency of 96% (288/300).

Line 1 in the Position column of the following chart, memorializes these results. The chart itself lists the efficiencies of the system of the present invention, at thirty six angular positions of the blades of each rotor unit. The average wind use efficiency is approximately 285.5%, for an overall efficiency of 95.1%, a result heretofore not achieved by any practical, working wind turbine system.

| | LEFT REAR ROTOR UNIT (12) | | | FORWARD ROTOR UNIT (2) | | | RIGHT REAR ROTOR UNIT (22) | | | TOTAL |
|---|---|---|---|---|---|---|---|---|---|---|
| Position | Blade (15) | Blade (14) | Blade (16) | Blade (5) | Blade (4) | Blade (6) | Blade (25) | Blade (24) | Blade (26) | EFFICIENCY * |
| 1 | 1 | 0 | 0 | 0 | 0.77 | 0.17 | 0 | 0.94 | 0 | 2.88 |
| 2 | 0.98 | 0 | 0 | 0 | 0.87 | 0 | 0 | 0.98 | 0 | 2.83 |
| 3 | 0.94 | 0 | 0 | 0 | 0.94 | 0 | 0 | 1 | 0 | 2.88 |
| 4 | 0.87 | 0 | 0 | 0 | 0.98 | 0 | 0 | 0.98 | 0 | 2.83 |
| 5 | 0.77 | 0.17 | 0 | 0 | 1 | 0 | 0 | 0.94 | 0 | 2.88 |
| 6 | 0.64 | 0.34 | 0 | 0 | 0.98 | 0 | 0 | 0.87 | 0 | 2.83 |
| 7 | 0.5 | 0.5 | 0 | 0 | 0.94 | 0 | 0.17 | 0.77 | 0 | 2.88 |
| 8 | 0.34 | 0.64 | 0 | 0 | 0.87 | 0 | 0.34 | 0.64 | 0 | 2.83 |
| 9 | 0.17 | 0.77 | 0 | 0.17 | 0.77 | 0 | 0.5 | 0.5 | 0 | 2.88 |
| 10 | 0 | 0.87 | 0 | 0.34 | 0.64 | 0 | 0.64 | 0.34 | 0 | 2.83 |
| 11 | 0 | 0.94 | 0 | 0.5 | 0.5 | 0 | 0.77 | 0.17 | 0 | 2.88 |
| 12 | 0 | 0.98 | 0 | 0.64 | 0.34 | 0 | 0.87 | 0 | 0 | 2.83 |
| 13 | 0 | 1 | 0 | 0.77 | 0.17 | 0 | 0.94 | 0 | 0 | 2.88 |
| 14 | 0 | 0.98 | 0 | 0.87 | 0 | 0 | 0.98 | 0 | 0 | 2.83 |
| 15 | 0 | 0.94 | 0 | 0.94 | 0 | 0 | 1 | 0 | 0 | 2.88 |
| 16 | 0 | 0.87 | 0 | 0.98 | 0 | 0 | 0.98 | 0 | 0 | 2.83 |
| 17 | 0 | 0.77 | 0.17 | 1 | 0 | 0 | 0.94 | 0 | 0 | 2.88 |
| 18 | 0 | 0.64 | 0.34 | 0.98 | 0 | 0 | 0.87 | 0 | 0 | 2.83 |
| 19 | 0 | 0.5 | 0.5 | 0.94 | 0 | 0 | 0.77 | 0 | 0.17 | 2.88 |
| 20 | 0 | 0.34 | 0.64 | 0.87 | 0 | 0 | 0.64 | 0 | 0.34 | 2.83 |
| 21 | 0 | 0.17 | 0.77 | 0.77 | 0 | 0.17 | 0.5 | 0 | 0.5 | 2.88 |
| 22 | 0 | 0 | 0.87 | 0.64 | 0 | 0.34 | 0.34 | 0 | 0.64 | 2.83 |
| 23 | 0 | 0 | 0.94 | 0.5 | 0 | 0.5 | 0.17 | 0 | 0.77 | 2.88 |
| 24 | 0 | 0 | 0.98 | 0.34 | 0 | 0.64 | 0 | 0 | 0.87 | 2.83 |
| 25 | 0 | 0 | 1 | 0.17 | 0 | 0.77 | 0 | 0 | 0.94 | 2.88 |
| 26 | 0 | 0 | 0.98 | 0 | 0 | 0.87 | 0 | 0 | 0.98 | 2.83 |
| 27 | 0 | 0 | 0.94 | 0 | 0 | 0.94 | 0 | 0 | 1 | 2.88 |
| 28 | 0 | 0 | 0.87 | 0 | 0 | 0.98 | 0 | 0 | 0.98 | 2.83 |
| 29 | 0.17 | 0 | 0.77 | 0 | 0 | 1 | 0 | 0 | 0.94 | 2.88 |
| 30 | 0.34 | 0 | 0.64 | 0 | 0 | 0.98 | 0 | 0 | 0.87 | 2.83 |
| 31 | 0.5 | 0 | 0.5 | 0 | 0 | 0.94 | 0 | 0.17 | 0.77 | 2.88 |
| 32 | 0.64 | 0 | 0.34 | 0 | 0 | 0.87 | 0 | 0.34 | 0.64 | 2.83 |
| 33 | 0.77 | 0 | 0.17 | 0 | 0.17 | 0.77 | 0 | 0.5 | 0.5 | 2.88 |
| 34 | 0.87 | 0 | 0 | 0 | 0.34 | 0.64 | 0 | 0.64 | 0.34 | 2.83 |
| 35 | 0.94 | 0 | 0 | 0 | 0.5 | 0.5 | 0 | 0.77 | 0.17 | 2.88 |
| 36 | 0.98 | 0 | 0 | 0 | 0.64 | 0.34 | 0 | 0.87 | 0 | 2.83 |
| 1 | 1 | 0 | 0 | 0 | 0.77 | 0.17 | 0 | 0.94 | 0 | 2.88 |

* All efficiencies calculated by multiplying by 100%.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A wind turbine system comprising:
a control housing mounted on a vertically oriented pole;
a first vertically oriented rotatable rotor unit mounted on the control housing, said rotor unit comprising rotatable blade means for receiving head on wind generated airflow and baffle means extending from the rotor unit for directing airflow both towards and away from the blade means to increase the wind-use efficiency of the system;
a second vertically oriented rotatable rotor unit mounted on the control housing and located rearward of the first rotor unit when the first rotor unit receives head on airflow, said second rotor unit comprising rotatable blade means for receiving airflow directed from both the blade means of the first rotor unit and from head on airflow;
a third vertically oriented rotatable rotor unit mounted on the control housing and located rearward of the first rotor unit and laterally of the second rotor unit when the first rotor unit receives head on airflow, said third rotor unit comprising rotatable blade means for receiving airflow from both the blade means of the first rotor unit and from head on airflow; and
gear means located within the control housing for driving a power generating device, each rotor unit being connected to the gear means and being synchronized to optimize rotation of the blade means resulting from ambient airflow.

2. The wind turbine system as in claim 1 wherein the first, second and third rotor units are mounted on the control housing in triangular configuration.

3. The wind turbine system as in claim 1 wherein the baffle means comprises a first baffle with opening means for receiving head on airflow and for directing airflow to the blade means of the first rotor unit to increase the rotation of said blade means.

4. The wind turbine system as in claim 3 wherein the first baffle further comprises second opening means for directing airflow from within the first rotor unit towards the second rotor unit to increase the rotation of the blade means of the second rotor unit.

5. The wind turbine system as in claim 3 wherein the baffle means further comprises a second baffle with opening means for receiving airflow from within the first rotor unit and for directing said airflow to one of the other two rotor units to increase the rotation of the blade means of that rotor unit.

6. The wind turbine system as in claim 1 further comprising shield means for the deflecting and discharging airflow from the second rotor unit and second shield means for deflecting and discharging airflow from the third rotor unit.

7. The wind turbine system as in claim 1 further comprising fin stabilizer means for continuously orienting the wind turbine system in the direction of the head on ambient airflow.

8. The wind turbine system as in claim 1 wherein the gear means comprises first rotor unit pinion gear, second rotor unit pinion gear, third rotor unit pinion gear, and power output pinion gear, said gear means further comprises interconnection means for transferring rotational power from the first rotor unit, second rotor unit and third rotor unit to the power output pinion gear to drive said power generating device.

9. The wind turbine system as in claim 1 wherein each of the rotor units further comprises rotatable shafts from which the respective blade means extend, each of the shafts being connected to the gear means.

10. The wind turbine system as in claim 9 wherein the baffle means extend from and are connected to the first rotor unit shaft.

11. The wind turbine system as in claim 6 wherein the shield means extend from the second rotor unit shaft and the second shield means extend from the third rotor unit shaft.

12. The wind turbine system as in claim 1 further comprising a top bracket to which the first, second and third rotor units are connected.

13. The wind turbine system as in claim 9 further comprising a top bracket to which the first, second, and third rotor units are connected.

14. The wind turbine system as in claim 13 wherein the pole is connected to the top bracket at a location equidistant from the shafts of the rotor units.

15. The wind turbine system as in claim 1 wherein the blade means of the first rotor unit comprises first, second, and third blades spaced 120° apart, the blade means of the second rotor unit comprises first, second, and third blades spaced 120° apart, and the blade means of the third rotor unit comprises first, second, and third blades spaced 120° apart.

16. The wind turbine system as in claim 15 wherein the first blade of the first rotor unit is set and, at all times, maintained at an angle of 20° ahead of the first blade of the second rotor unit and 20° behind the first blade of the third rotor unit, the second blade of the first rotor unit is set and, at all times, maintained at an angle of 20° ahead of the second blade of the second rotor unit and 20° behind the second blade of the third rotor unit, and the third blade of the first rotor unit is set and, at all times, maintained at an angle of 20° ahead of the third blade of the second rotor unit and 20° behind the third blade of the third rotor unit, so that the combined ambient airflow rotation of the three rotor units maximizes the power generated by the wind turbine system.
